(19) United States
(12) Patent Application Publication
(10) Pub. No.: US 2017/0076850 A1
(43) Pub. Date: Mar. 16, 2017

(54) Coupled Inductor and Power Converter

(71) Applicant: Huawei Technologies Co., Ltd., Shenzhen (CN)

(72) Inventors: Yunfeng Liu, Shanghai (CN); Fei Ye, Shanghai (CN); Yanshen Hu, Shenzhen (CN)

(21) Appl. No.: 15/360,572

(22) Filed: Nov. 23, 2016

Related U.S. Application Data
(63) Continuation of application No. PCT/CN2014/090442, filed on Nov. 6, 2014.

(30) Foreign Application Priority Data
May 27, 2014 (CN) 201410228172.4

(51) Int. Cl. H01F 27/255; G05F 3/02

(52) U.S. Cl. CPC H01F 27/255; G05F 3/02

(57) ABSTRACT

A coupled inductor and a power converter. The coupled inductor includes a magnetic core and at least two windings. The magnetic core includes at least two first magnetic cylinders, at least one second magnetic cylinder, and two opposite magnet yokes. The at least two first magnetic cylinders and the at least one second magnetic cylinder are disposed between the two opposite magnet yokes, the at least two windings are respectively located on the at least two first magnetic cylinders, and the at least two windings are in a one-to-one correspondence with the at least two first magnetic cylinders. Leakage inductance of the coupled inductor is increased by adding a second magnetic cylinder between the opposite magnet yokes of the coupled inductor, thereby meeting a requirement of system stability when the coupled inductor is connected to the power converter.

### CROSS-REFERENCE TO RELATED APPLICATIONS

This application is a continuation of International Application No. PCT/CN2014/090442, filed on Nov. 6, 2014, which claims priority to Chinese Patent Application No. 201410228172.4, filed on May 27, 2014, both of which are hereby incorporated by reference in their entireties.

### TECHNICAL FIELD

The present application relates to the field of circuits, and in particular, to a coupled inductor and a power converter.

### BACKGROUND

Currently, multi-level power converters using an interleaved parallel technology have been widely applied. This type of multi-level power converter includes multiple power bridge arms connected in parallel. The multiple power bridge arms are coupled by using multiple windings or coils in a coupled inductor and run in an interleaved manner. The interleaved parallel technology can reduce an output ripple current and improve a frequency of output and therefore output inductance of a filter inductor can be reduced, thereby reducing a volume and costs of the inductor.

To meet a requirement of the multi-level power converter on system stability, a filter inductor generally needs to be disposed to provide enough inductance of the filter inductor. Because the coupled inductor can generate leakage inductance, the leakage inductance of the coupled inductor can be used in the multi-level power converter to replace the filter inductor of the multi-level power converter. This not only can reduce system costs and but also can improve system performance.

However, because the leakage inductance in the coupled inductor has relatively low inductance, which is equivalent to the filter inductor having relatively low inductance, when the coupled inductor is connected to the power converter, performance requirements such as system stability, a ripple current, and total harmonic distortion of current on input (THDi) cannot be met.

### SUMMARY

Embodiments of the present application provide a coupled inductor and a power converter, which can increase inductance of leakage inductance of the coupled inductor, thereby improving performance of a power converter connected to the coupled inductor.

According to a first aspect, a coupled inductor is provided, including a magnetic core and at least two windings, where the magnetic core includes at least two first magnetic cylinders, at least one second magnetic cylinder, and two opposite magnet yokes. The at least two first magnetic cylinders and the at least one second magnetic cylinder are disposed between the two opposite magnet yokes, the at least two windings are respectively located on the at least two first magnetic cylinders, and the at least two windings are in a one-to-one correspondence with the at least two first magnetic cylinders.

With reference to the first aspect, in a first possible implementation manner, a cross section of the at least one second magnetic cylinder is set to enable inductance of leakage inductance that is generated by the coupled inductor when the coupled inductor is connected to a power converter, to meet inductance, which is needed by the power converter, of a filter inductor.

With reference to the first aspect or the first possible implementation manner of the first aspect, in a second possible implementation manner, magnetic permeability of the at least two first magnetic cylinders is greater than magnetic permeability of the at least one second magnetic cylinder.

With reference to the first aspect or either of the first and second possible implementation manners of the first aspect, in a third possible implementation manner, the at least two first magnetic cylinders include N first magnetic cylinders, the at least one second magnetic cylinder includes N−1 second magnetic cylinders, and each second magnetic cylinder of the N−1 second magnetic cylinders is disposed between two first magnetic cylinders of the N first magnetic cylinders, where N is an integer greater than or equal to 2.

With reference to the third possible implementation manner, in a fourth possible implementation manner, the at least two first magnetic cylinders include two first magnetic cylinders and the at least one second magnetic cylinder includes one second magnetic cylinder.

With reference to the third possible implementation manner, in a fifth possible implementation manner, the at least two first magnetic cylinders include three first magnetic cylinders and the at least one second magnetic cylinder includes two second magnetic cylinders.

With reference to the first aspect or either of the first and second possible implementation manners of the first aspect, in a sixth possible implementation manner, the at least two first magnetic cylinders include three first magnetic cylinders, the at least one second magnetic cylinder includes one second magnetic cylinder, the three first magnetic cylinders are arranged in a triangle, and the second magnetic cylinder is disposed in the middle of the triangle.

With reference to the first aspect or either of the first and second possible implementation manners of the first aspect, in a seventh possible implementation manner, the at least two first magnetic cylinders include two first magnetic cylinders, the at least one second magnetic cylinder includes one second magnetic cylinder, and the two first magnetic cylinders and the second magnetic cylinder are arranged in a triangle.

With reference to the first aspect or any one of the foregoing possible implementation manners, in an eighth possible implementation manner, a material of the at least two first magnetic cylinders is a magnetic material having no interior air gap and a material of the at least one second magnetic cylinder is a magnetic material having an interior air gap.

With reference to the first aspect or any one of the foregoing possible implementation manners, in a ninth possible implementation manner, the magnetic material having no interior air gap includes an amorphous material, a ferrite material, or a silicon steel material, and the magnetic material having an interior air gap includes an iron-silicon material, an iron-silicon-aluminum material, or an amorphous powder.

With reference to the first aspect or any one of the foregoing possible implementation manners, in a tenth possible implementation manner, the at least two first magnetic cylinders and the at least one second magnetic cylinder have a cylinder, triangular prism, rectangular, or polygonal prism shape.

With reference to the first aspect or any one of the foregoing possible implementation manners, in an eleventh possible implementation manner, the two opposite magnet yokes have a round, triangular, rectangular, or polygonal shape.

According to a second aspect, a power converter is provided, including at least two power bridge arms and the coupled inductor according to any one of the possible implementation manners of the first aspect, where at least two windings of the coupled inductor are respectively connected to the at least two power bridge arms.

Based on the foregoing technical solutions, leakage inductance of the coupled inductor can be increased by adding a second magnetic cylinder between the two opposite magnet yokes of the coupled inductor, thereby improving performance of the power converter connected to the coupled inductor.

### BRIEF DESCRIPTION OF DRAWINGS

To describe the technical solutions in the embodiments of the present application more clearly, the following briefly describes the accompanying drawings required for describing the embodiments of the present application. The accompanying drawings in the following description show merely some embodiments of the present application and a person of ordinary skill in the art may still derive other drawings from these accompanying drawings without creative efforts.

FIG. 1 is a schematic diagram of a structure of a coupled inductor according to an embodiment of the present application;

FIG. 2 is a cross-section view of a structure of a coupled inductor according to another embodiment of the present application;

FIG. 3 is a cross-section view of a structure of a coupled inductor according to another embodiment of the present application;

FIG. 4 is a schematic diagram of a structure of a coupled inductor according to another embodiment of the present application;

FIG. 5 is a schematic diagram of a structure of a coupled inductor according to another embodiment of the present application;

FIG. 6 is a schematic diagram of a structure of a coupled inductor according to another embodiment of the present application;

FIG. 7 is a cross-section view of a structure of a coupled inductor according to another embodiment of the present application;

FIG. 8 is a cross-section view of a structure of a coupled inductor according to another embodiment of the present application; and

FIG. 9 is a schematic structural diagram of a power converter according to an embodiment of the present application.

### DESCRIPTION OF EMBODIMENTS

The following clearly describes the technical solutions in the embodiments of the present application with reference to the accompanying drawings in the embodiments of the present application. The described embodiments are a part rather than all of the embodiments of the present application. All other embodiments obtained by a person of ordinary skill in the art based on the embodiments of the present application without creative efforts shall fall within the protection scope of the present application.

The embodiments of the present application are applied to a multi-level power converter using an interleaved and parallel technology. In the embodiments of the present application, a level of an electrical level of the multi-level power converter is not limited. For example, the multi-level power converter may be a two-level power converter, a three-level power converter, a five-level power converter, or the like. In the embodiments of the present application, a type of the multi-level power converter is not limited either. For example, the multi-level power converter may be a diode-clamped multi-level power converter, a capacitor-clamped multi-level power converter, or the like.

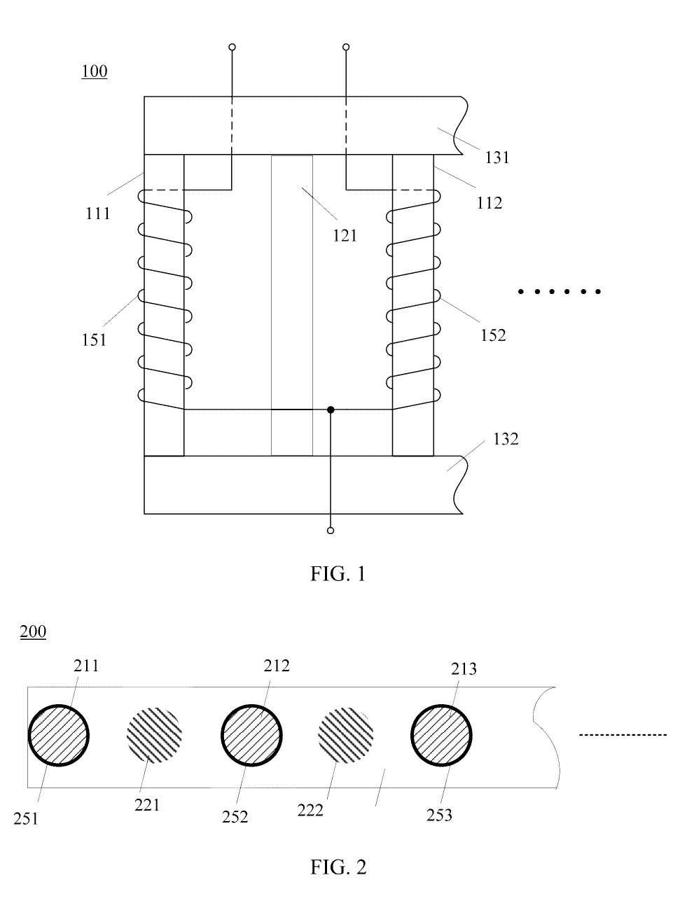

FIG. 1 is a schematic diagram of a structure of a coupled inductor 100 according to an embodiment of the present application.

The coupled inductor 100 includes a magnetic core and at least two windings. The magnetic core includes at least two first magnetic cylinders, at least one second magnetic cylinder, and two opposite magnet yokes. The at least two first magnetic cylinders and the at least one second magnetic cylinder are disposed between the two opposite magnet yokes, the at least two windings are respectively located on the at least two first magnetic cylinders, and the at least two windings are in a one-to-one correspondence with the at least two first magnetic cylinders.

As shown in FIG. 1, a magnetic core includes two first magnetic cylinders 111 and 112, a second magnetic cylinder 121, an upper magnet yoke 131, and a lower magnet yoke 132. The two first magnetic cylinders 111 and 112 and the second magnetic cylinder 121 are separately disposed between the upper magnet yoke 131 and the lower magnet yoke 132. Two windings 151 and 152 are respectively wound around the two first magnetic cylinders 111 and 112. The two windings 151 and 152 are in a one-to-one correspondence with the two first magnetic cylinders 111 and 112.

When the coupled inductor is connected to a power converter, one end of the winding 151 and one end of the winding 152 are short-circuited and are connected to a load, and the other end of the winding 151 and the other end of the winding 152 are respectively connected to power bridge arms of the power converter. The windings 151 and 152 are configured to couple alternating currents that are generated by the power bridge arms by working in an interleaved manner. In addition, magnetic flux generated by the windings 151 and 152 causes leakage inductance through air and the magnetic flux generated by the windings 151 and 152 also causes leakage inductance through the second magnetic cylinder.

In this embodiment of the present application, leakage inductance of the coupled inductor can be increased by adding a second magnetic cylinder between the two opposite magnet yokes of the coupled inductor, thereby improving performance of the power converter connected to the coupled inductor. For example, performance requirements such as system stability, a ripple current, and THDi can be met. In addition, because this type of coupled inductor includes a magnetic cylinder without a coil wound around the magnetic cylinder, a processing technique is simple and a demand for mass production can be met. In addition, because the leakage inductance of the coupled inductor is used to replace a filter inductor, system costs are reduced and losses caused by use of the filter inductor are reduced, thereby improving system efficiency.

It should be understood that, for ease of description, FIG. 1 only shows a part of the structure of the coupled inductor 100, and the technical solution in this embodiment of the present application is described in detail by using the part of the structure as an example. However, this embodiment of the present application is not limited to this.

According to this embodiment of the present application, magnetic permeability of a material of the at least two first magnetic cylinders is greater than magnetic permeability of a material of the at least one second magnetic cylinder. In other words, the first magnetic cylinder may be made from a high magnetic permeability material, and the second magnetic cylinder may be made from a low magnetic permeability material.

According to this embodiment of the present application, the material of the at least two first magnetic cylinders may be a magnetic material having no interior air gap, for example, an amorphous material, a ferrite material, or a silicon steel material, and the material of the at least one second magnetic cylinder may be a magnetic material having an interior air gap, for example, an iron-silicon material, an iron-silicon-aluminum material, or an amorphous powder. For example, a material of the first magnetic cylinders 111 and 112 may be a ferrite material and a material of the second magnetic cylinder 121 may be an iron-silicon material.

It should be understood that the material of the at least two first magnetic cylinders may also be another magnetic material having no air gap inside and the material of the at least one second magnetic cylinder may also be another magnetic material having an air gap inside. This embodiment of the present application is not limited to this.

According to this embodiment of the present application, the material of the at least one second magnetic cylinder may also be a magnetic material having no air gap inside and each second magnetic cylinder of the at least one second magnetic cylinder includes two parts, where an air gap having a millimeter (mm)-scale interval is disposed between the two parts. Therefore, each second magnetic cylinder of the at least one second magnetic cylinder may be equivalent to a magnetic cylinder made from of a low magnetic permeability magnetic material. For example, a material of the second magnetic cylinder 121 may be a ferrite material and the second magnetic cylinder 121 includes a first part and a second part, where an air gap having an interval of 1 mm to 3 mm is disposed between the first part and the second part. Therefore, the second magnetic cylinder 121 is equivalent to a magnetic cylinder made from a low magnetic permeability magnetic material.

According to this embodiment of the present application, the at least two first magnetic cylinders and the at least one second magnetic cylinder may have a cylinder, triangular prism, rectangular, or polygonal prism shape. The shape of the first magnetic cylinder may be the same as or may be different from the shape of the second magnetic cylinder. For example, the first magnetic cylinders 111 and 112 and the second magnetic cylinder 121 may have a cylinder shape; or the first magnetic cylinders 111 and 112 may have a cylinder shape, but the second magnetic cylinder 121 may have a polygonal prism shape.

According to this embodiment of the present application, the two opposite magnet yokes may have a round, triangular, rectangular, or polygonal shape. It should be understood that, the two opposite magnet yokes may also have a round triangle shape, a round rectangle shape, or another shape similar to a round rectangle. For example, the two opposite magnet yokes, the upper magnet yoke 131 and the lower magnet yoke 132, have a round triangle shape.

According to this embodiment of the present application, in the coupled inductor 100 shown in FIG. 1, a cross section of the at least one second magnetic cylinder is set to enable inductance of leakage inductance that is generated by the coupled inductor 100 when the coupled inductor 100 is connected to the power converter, to meet inductance, which is needed by the power converter including the coupled inductor 100, of a filter inductor.

For example, a size of the cross section of the second magnetic cylinder 121 may be set to enable the inductance of the leakage inductance of the coupled inductor 100 to meet the inductance, which is needed by the power converter including the coupled inductor 100, of the filter inductor.

Therefore, in this embodiment of the present application, a coupling factor of a coupled inductor is adjusted by setting a size of a cross section of at least one second magnetic cylinder so that inductance of leakage inductance of the coupled inductor can meet inductance, which is needed by a power converter including the coupled inductor, of a filter inductor, and control precision is relatively high.

According to this embodiment of the present application, in the coupled inductor shown in FIG. 1, the at least one second magnetic cylinder may be disposed at a position adjacent to the at least two first magnetic cylinders and the at least two first magnetic cylinders may be parallel to the at least one second magnetic cylinder.

It should be understood that the at least one second magnetic cylinder is disposed at a position adjacent to the at least two first magnetic cylinders and the at least one second magnetic cylinder and the at least two first magnetic cylinders may be located in a same plane or may be located in different planes. In other words, the at least one second magnetic cylinder and the at least two first magnetic cylinders may be located in one straight line, or the at least two first magnetic cylinders are located in one straight line and at least one second magnetic cylinder is located in another straight line.

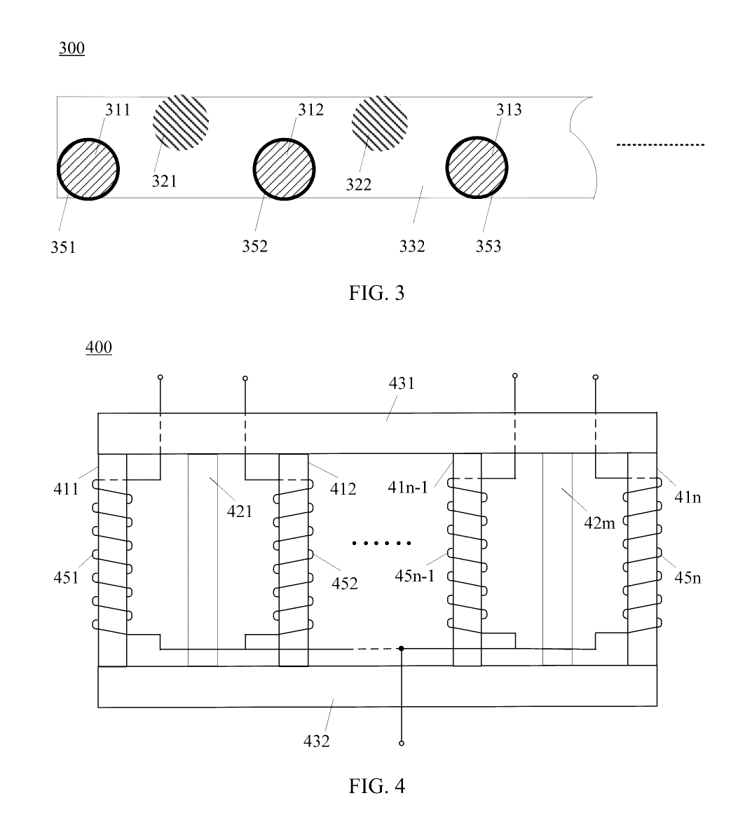

The following describes the technical solution in this embodiment of the present application in detail with reference to embodiments shown in FIG. 2 and FIG. 3, but this embodiment of the present application is not limited to this.

FIG. 2 is a cross-section view of a structure of a coupled inductor 200 according to another embodiment of the present application. The coupled inductor 200 is an example of the embodiment in FIG. 1. The coupled inductor 200 is similar to the coupled inductor 100 in FIG. 1 and a detailed description is appropriately omitted herein.

FIG. 2 exemplarily shows in part a magnetic core and at least two windings of the coupled inductor. First magnetic cylinders 211, 212, and 213 and second magnetic cylinders 221 and 222 are arranged along a straight line. The second magnetic cylinder 221 is located between the first magnetic cylinders 211 and 212, and the second magnetic cylinder 222 is located between the first magnetic cylinders 212 and 213. Windings 251, 252, and 253 are respectively wound around the first magnetic cylinders 211, 212, and 213.

In this embodiment of the present application, leakage inductance of the coupled inductor can be increased by adding a second magnetic cylinder between the two opposite magnet yokes of the coupled inductor, thereby improving performance of the power converter connected to the coupled inductor. In addition, because this type of coupled inductor includes a magnetic cylinder without a coil wound around the magnetic cylinder, a processing technique is simple and a demand for mass production can be met. In addition, because the leakage inductance of the coupled inductor is used to replace a filter inductor, system costs are reduced and losses caused by use of the filter inductor are reduced, thereby improving system efficiency.

In addition, because the added at least one second magnetic cylinder is disposed between at least two first magnetic cylinders, a volume of the coupled inductor does not increase, which is beneficial to a space layout of a system.

FIG. 3 is a cross-section view of a structure of a coupled inductor 300 according to another embodiment of the present application. The coupled inductor 300 is an example of the embodiment in FIG. 1. The coupled inductor 300 is similar to the coupled inductor 100 in FIG. 1 and a detailed description is appropriately omitted herein.

FIG. 3 exemplarily shows in part a magnetic core and at least two windings, of the coupled inductor. First magnetic cylinders 311, 312, and 313 are arranged along a straight line, and second magnetic cylinders 321 and 322 are arranged along a straight line on a magnetic yoke 332. The second magnetic cylinder 321 is located between the first magnetic cylinders 311 and 312, and the second magnetic cylinder 322 is located between the first magnetic cylinders 312 and 313. Windings 351, 352, and 353 are respectively wound around the first magnetic cylinders 311, 312, and 313.

In this embodiment of the present application, leakage inductance of the coupled inductor can be increased by adding a second magnetic cylinder between the two opposite magnet yokes of the coupled inductor, thereby improving performance of the power converter connected to the coupled inductor. In addition, because this type of coupled inductor includes a magnetic cylinder without a coil wound around the magnetic cylinder, a processing technique is simple and a demand for mass production can be met. In addition, because the leakage inductance of the coupled inductor is used to replace a filter inductor, system costs are reduced and losses caused by use of the filter inductor are reduced, thereby improving system efficiency.

FIG. 4 is a schematic diagram of a structure of a coupled inductor 400 according to another embodiment of the present application. The coupled inductor 400 is an example of the embodiment in FIG. 1. The coupled inductor 400 is similar to the coupled inductor 100 in FIG. 1 and a detailed description is appropriately omitted herein.

At least two first magnetic cylinders include N first magnetic cylinders, at least one second magnetic cylinder includes N−1 second magnetic cylinders, and each second magnetic cylinder of the N−1 second magnetic cylinders is disposed between two first magnetic cylinders of the N first magnetic cylinders, where N is an integer greater than or equal to 2.

As shown in FIG. 4, the N first magnetic cylinders are separately first magnetic cylinders 411, 412, . . . , and 41n, and the N−1 second magnetic cylinders are separately second magnetic cylinder 421, . . . , and 42m, where m=n−1. The first magnetic cylinders 411, 412, . . . , and 41n and the second magnetic cylinders 421, . . . , and 42m are disposed between an upper magnet yoke 431 and a lower magnet yoke 432. The i^{th} second magnetic cylinder of the second magnetic cylinders 421, . . . , and 42m is disposed between the i^{th} first magnetic cylinder and the (i+1)^{th} first magnetic cylinder of the first magnetic cylinders 411, 412, . . . , and 41n, where a value of i ranges from 1 to m. For example, the second magnetic cylinder 421 is disposed between the first magnetic cylinders 411 and 412, and the second magnetic cylinder 42m is disposed between the first magnetic cylinders 41n-1 and 41n. Windings 451, 452, . . . , and 45n-1, 45n are respectively wound around the first magnetic cylinders 411, 412, . . . , and 41n.

In this embodiment of the present application, leakage inductance of the coupled inductor can be increased by adding a second magnetic cylinder between the two opposite magnet yokes of the coupled inductor, thereby improving performance of the power converter connected to the coupled inductor. In addition, because this type of coupled inductor includes a magnetic cylinder without a coil wound around the magnetic cylinder, a processing technique is simple and a demand for mass production can be met. In addition, because the leakage inductance of the coupled inductor is used to replace a filter inductor, system costs are reduced and losses caused by use of the filter inductor are reduced, thereby improving system efficiency.

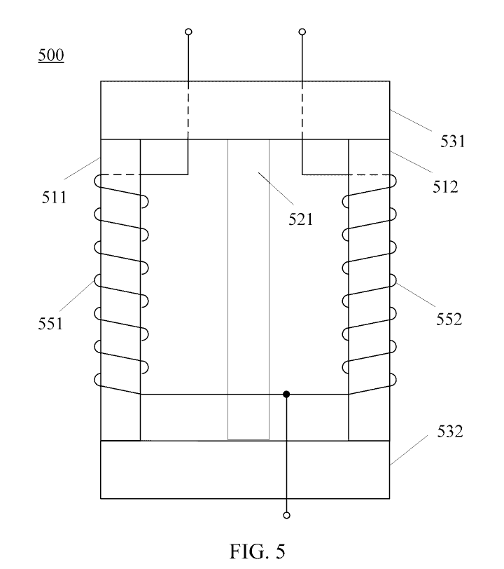

FIG. 5 is a schematic diagram of a structure of a coupled inductor 500 according to another embodiment of the present application. The coupled inductor 500 is an example of the embodiment in FIG. 1 or FIG. 2. The coupled inductor 500 is similar to the coupled inductor 100 in FIG. 1 and a detailed description is appropriately omitted herein.

According to this embodiment of the present application, the coupled inductor 500 includes two first magnetic cylinders 511 and 512, one second magnetic cylinder 521, an upper magnet yoke 531, a lower magnet yoke 532, and two windings 551 and 552. The first magnetic cylinders 511 and 512 and the second magnetic cylinder 521 are disposed between the upper magnet yoke 531 and the lower magnet yoke 532, and the second magnetic cylinder 521 is located between the first magnetic cylinders 511 and 512. The winding 551 is wound around the first magnetic cylinder 511, and the winding 552 is wound around the first magnetic cylinder 512.

Therefore, in this embodiment of the present application, leakage inductance of the coupled inductor can be increased by adding a second magnetic cylinder between the two opposite magnet yokes of the coupled inductor, thereby improving performance of the power converter connected to the coupled inductor. In addition, because this type of coupled inductor includes a magnetic cylinder without a coil wound around the magnetic cylinder, a processing technique is simple and a demand for mass production can be met. In addition, because the leakage inductance of the coupled inductor is used to replace a filter inductor, system costs are reduced and losses caused by use of the filter inductor are reduced, thereby improving system efficiency.

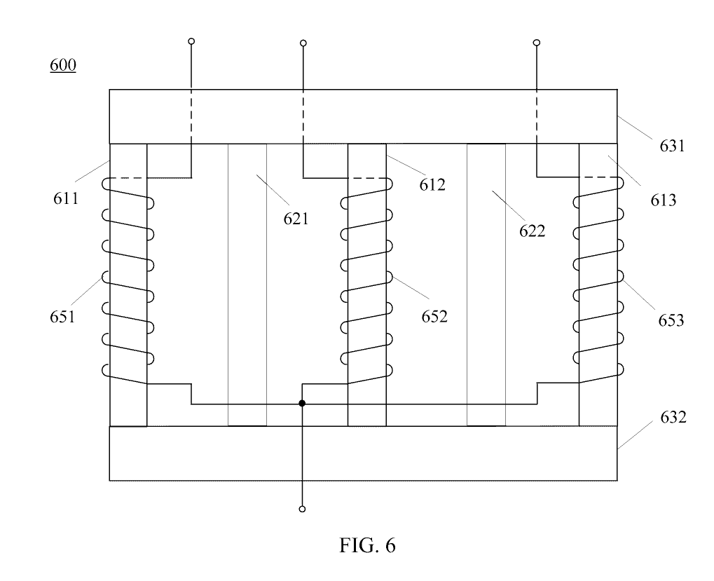

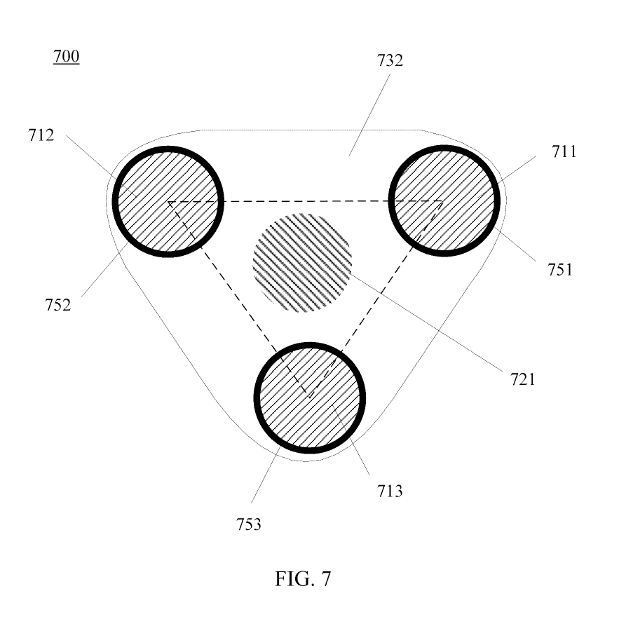

FIG. 6 is a schematic diagram of a structure of a coupled inductor 600 according to another embodiment of the present application. The coupled inductor 600 is an example of the embodiment in FIG. 1 or FIG. 2. The coupled inductor 600 is similar to the coupled inductor 100 in FIG. 1 and a detailed description is appropriately omitted herein.

In the coupled inductor 600 shown in FIG. 6, N first magnetic cylinders are three first magnetic cylinders, and N−1 second magnetic cylinders are two second magnetic cylinders.

According to this embodiment of the present application, the coupled inductor 600 includes three first magnetic cylinders 611, 612, and 613, two second magnetic cylinders 621 and 622, an upper magnet yoke 631, a lower magnet yoke 632, and three windings 651, 652, and 653. The first magnetic cylinders 611, 612, and 613 and the two second magnetic cylinders 621 and 622 are disposed between the upper magnet yoke 631 and the lower magnet yoke 632. The second magnetic cylinder 621 is located between the first magnetic cylinders 611 and 612 and the second magnetic cylinder 622 is located between the first magnetic cylinders 612 and 613. The winding 651 is wound around the first magnetic cylinder 611, the winding 652 is wound around the first magnetic cylinder 612, and the winding 653 is wound around the first magnetic cylinder 613.

Therefore, in this embodiment of the present application, leakage inductance of the coupled inductor can be increased by adding a second magnetic cylinder between the two opposite magnet yokes of the coupled inductor, thereby improving performance of the power converter connected to the coupled inductor. In addition, because this type of coupled inductor includes a magnetic cylinder without a coil wound around the magnetic cylinder, a processing technique is simple and a demand for mass production can be met. In addition, because the leakage inductance of the coupled inductor is used to replace a filter inductor, system costs are reduced and losses caused by use of the filter inductor are reduced, thereby improving system efficiency.

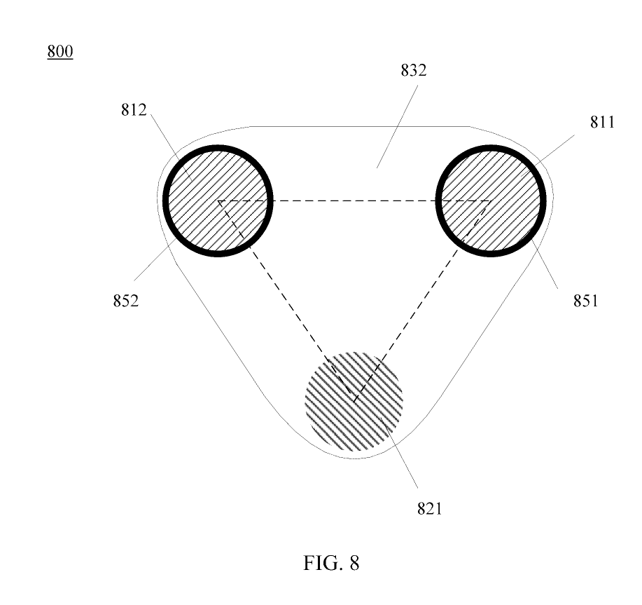

FIG. 7 is a cross-section view of a structure of a coupled inductor 700 according to another embodiment of the present application. The coupled inductor 700 is an example of the embodiment in FIG. 1 or FIG. 3. The coupled inductor 700 is similar to the coupled inductor 100 in FIG. 1 and a detailed description is appropriately omitted herein.

In the coupled inductor 700 shown in FIG. 7, at least one first magnetic cylinder includes three first magnetic cylinders 711, 712, and 713, and at least one second magnetic cylinder includes one second magnetic cylinder 721. The three first magnetic cylinders are arranged in a triangle, and the second magnetic cylinder is disposed in the middle of the triangle.

According to this embodiment of the present application, the coupled inductor 700 includes three first magnetic cylinders 711, 712, and 713, one second magnetic cylinder 721, an upper magnet yoke (not shown), a lower magnet yoke 732, and three windings 751, 752, and 753. The first magnetic cylinders 711, 712, and 713 and the second magnetic cylinder 721 are disposed between the upper magnet yoke and the lower magnet yoke 732, and the three first magnetic cylinders 711, 712, and 713 are arranged in a triangle. That is, the three first magnetic cylinders 711, 712, and 713 are respectively located at three vertex angles of the triangle, and the second magnetic cylinder 721 is located in the middle of the triangle. The winding 751 is wound around the first magnetic cylinder 711, the winding 752 is wound around the first magnetic cylinder 712, and the winding 753 is wound around the first magnetic cylinder 713.

Herein, a description is provided by only using an example in which the magnet yokes have a round triangle shape, and the first magnetic cylinders 711, 712, and 713 and the second magnetic cylinder 721 have a round shape. This embodiment of the present application is not limited to this. For example, the magnet yokes may also have another shape, for example, a round or rectangular shape, and the first magnetic cylinders and the second magnetic cylinder may also have another shape, for example, a polygonal shape.

Therefore, in this embodiment of the present application, leakage inductance of the coupled inductor can be increased by adding a second magnetic cylinder between the two opposite magnet yokes of the coupled inductor, thereby improving performance of the power converter connected to the coupled inductor. In addition, because this type of coupled inductor includes a magnetic cylinder without a coil wound around the magnetic cylinder, a processing technique is simple and a demand for mass production can be met. In addition, because the leakage inductance of the coupled inductor is used to replace a filter inductor, system costs are reduced and losses caused by use of the filter inductor are reduced, thereby improving system efficiency.

FIG. 8 is a cross-section view of a structure of a coupled inductor 800 according to another embodiment of the present application. The coupled inductor 800 is an example of the embodiment in FIG. 1 or FIG. 3. The coupled inductor 800 is similar to the coupled inductor 100 in FIG. 1 and a detailed description is appropriately omitted herein.

In the coupled inductor 800 shown in FIG. 8, at least two first magnetic cylinders include two first magnetic cylinders, at least one second magnetic cylinder includes one second magnetic cylinder, and the two first magnetic cylinders and the second magnetic cylinder are arranged in a triangle.

According to this embodiment of the present application, the coupled inductor 800 includes two first magnetic cylinders 811 and 812, one second magnetic cylinder 821, an upper magnet yoke (not shown), a lower magnet yoke 832, and two windings 851 and 852. The first magnetic cylinders 811 and 812 and the second magnetic cylinder 821 are disposed between an upper magnet yoke 831 and the lower magnet yoke 832, and the two first magnetic cylinders 811 and 812 and the second magnetic cylinder 821 are arranged in a triangle. That is, the two first magnetic cylinders 811 and 812 and the second magnetic cylinder 821 are respectively located at three vertex angles of the triangle. The winding 851 is wound around the first magnetic cylinder 811, and the winding 852 is wound around the first magnetic cylinder 812. The second magnetic cylinder 821 is not wound with a winding.

Herein, a description is provided by only using an example in which the magnet yokes have a round triangle shape, and the first magnetic cylinders 811 and 812 and the second magnetic cylinder 821 have a round shape. This embodiment of the present application is not limited to this. For example, the magnet yokes may also have another shape, for example, a round or rectangular shape, and the first magnetic cylinders and the second magnetic cylinder may also have another shape, for example, a polygonal shape.

Therefore, in this embodiment of the present application, leakage inductance of the coupled inductor can be increased by adding a second magnetic cylinder between the two opposite magnet yokes of the coupled inductor, thereby improving performance of the power converter connected to the coupled inductor. In addition, because this type of coupled inductor includes a magnetic cylinder without a coil wound around the magnetic cylinder, a processing technique is simple and a demand for mass production can be met. In addition, because the leakage inductance of the coupled inductor is used to replace a filter inductor, system costs are reduced and losses caused by use of the filter inductor are reduced, thereby improving system efficiency.

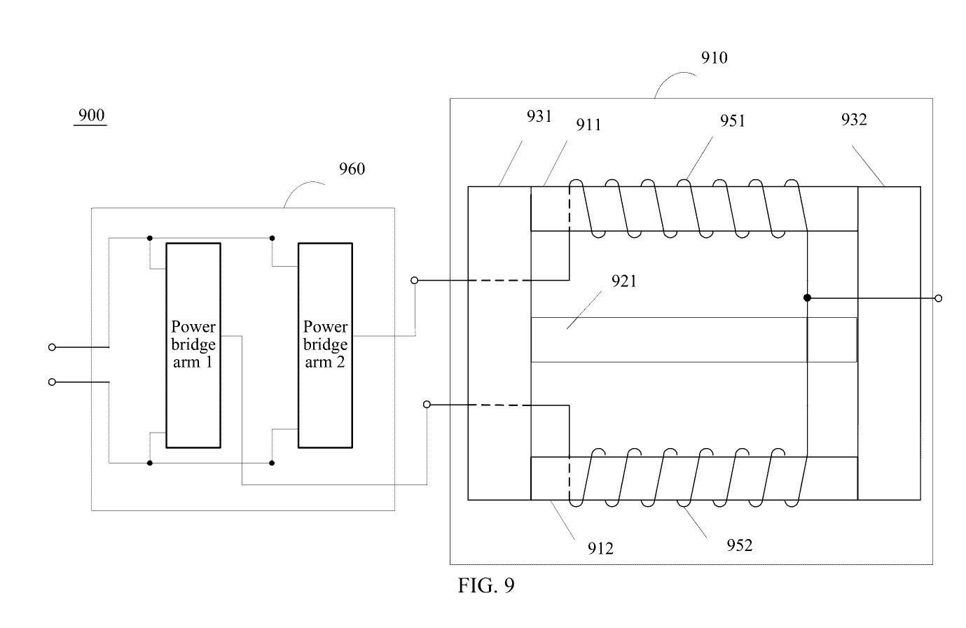

FIG. 9 is a schematic structural diagram of a power converter 900 according to an embodiment of the present application. The power converter 900 includes at least two power bridge arms and the coupled inductor described in the foregoing embodiments. At least two windings of the coupled inductor are respectively connected to the at least two power bridge arms.

The following description is provided by using two power bridge arms 960 as an example and this embodiment of the present application is not limited to this. The coupled inductor in this embodiment of the present application may be connected to multiple power bridge arms and each power bridge arm corresponds to one input end of the coupled inductor.

The power converter 900 shown in FIG. 9 includes two power bridge arms 960 and a coupled inductor 910.

A structure of the coupled inductor 910 is the same as the coupled inductor 500 shown in FIG. 5 in the foregoing embodiments of the coupled inductor and a detailed description is appropriately omitted herein. Output ends of the two power bridge arms 960 are respectively connected to input ends of two windings 951 and 952 included in the coupled inductor 910.

An input end of a power bridge arm 1 and an input end of a power bridge arm 2 are connected in parallel between two input ends of the power converter 900. An output end of the power bridge arm 1 is connected to an input end of the winding 952 of the coupled inductor. An output end of the power bridge arm 2 is connected to an input end of the winding 951 of the coupled inductor. Output ends of the windings 951 and 952 are connected to an output end of the power converter 900. The output end of the power converter 900 is connected to a load (not shown). The coupled inductor 910 includes first magnetic cylinders 911 and 912, a second magnetic cylinder 921, an upper magnet yoke 931, a lower magnet yoke 932, and the two windings 951 and 952. The first magnetic cylinders 911 and 912 and the second magnetic cylinder 921 are disposed between the upper magnet yoke 931 and the lower magnet yoke 932 and the second magnetic cylinder 921 is located between the first magnetic cylinders 911 and 912. The winding 951 is wound around the first magnetic cylinder 911 and the winding 952 is wound around the first magnetic cylinder 912.

Therefore, according to the power converter in this embodiment of the present application, leakage inductance of the coupled inductor can be increased by adding a second magnetic cylinder between the two opposite magnet yokes of the coupled inductor, thereby improving performance of the power converter connected to the coupled inductor. In addition, a processing technique for this type of coupled inductor is simple and a demand for mass production can be met. In addition, because the leakage inductance of the coupled inductor is used to replace a filter inductor, system costs are reduced and losses caused by use of the filter inductor are reduced, thereby improving system efficiency.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit.

The foregoing descriptions are merely specific implementation manners of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A coupled inductor comprising:
a magnetic core comprising:
at least two first magnetic cylinders;
at least one second magnetic cylinder; and
two opposite magnet yokes, wherein the at least two first magnetic cylinders and the at least one second magnetic cylinder are disposed between the two opposite magnet yokes; and
at least two windings respectively located on the at least two first magnetic cylinders, wherein the at least two windings are in a one-to-one correspondence with the at least two first magnetic cylinders.

2. The coupled inductor according to claim 1, wherein a cross section of the at least one second magnetic cylinder is set to enable inductance of leakage inductance that is generated by the coupled inductor when the coupled inductor is connected to a power converter to meet a requirement for inductance, which is needed by the power converter, of a filter inductor.

3. The coupled inductor according to claim 1, wherein magnetic permeability of the at least two first magnetic cylinders is greater than magnetic permeability of the at least one second magnetic cylinder.

4. The coupled inductor according to claim 1, wherein the at least two first magnetic cylinders comprise N first magnetic cylinders, wherein the at least one second magnetic cylinder comprises N−1 second magnetic cylinders, wherein each second magnetic cylinder of the N−1 second magnetic cylinders is disposed between two first magnetic cylinders of the N first magnetic cylinders, and wherein N is an integer greater than or equal to 2.

5. The coupled inductor according to claim 4, wherein the at least two first magnetic cylinders comprise two first magnetic cylinders, and wherein the at least one second magnetic cylinder comprises one second magnetic cylinder.

6. The coupled inductor according to claim 4, wherein the at least two first magnetic cylinders comprise three first magnetic cylinders, and wherein the at least one second magnetic cylinder comprises two second magnetic cylinders.

7. The coupled inductor according to claim 1, wherein the at least two first magnetic cylinders comprise three first magnetic cylinders, wherein the at least one second magnetic cylinder comprises one second magnetic cylinder, wherein the three first magnetic cylinders are arranged in a triangle, and wherein the second magnetic cylinder is disposed in the middle of the triangle.

8. The coupled inductor according to claim 1, wherein the at least two first magnetic cylinders comprise two first magnetic cylinders, wherein the at least one second magnetic cylinder comprises one second magnetic cylinder, and wherein the two first magnetic cylinders and the second magnetic cylinder are arranged in a triangle.

9. The coupled inductor according to claim 1, wherein a material of the at least two first magnetic cylinders is a magnetic material having no interior air gap, and wherein a material of the at least one second magnetic cylinder is a magnetic material having an interior air gap.

10. The coupled inductor according to claim 9, wherein the magnetic material having no interior air gap comprises an amorphous material, a ferrite material, or a silicon steel material, and the magnetic material having an interior air gap comprises an iron-silicon material, an iron-silicon-aluminum material, or an amorphous powder.

11. The coupled inductor according to claim 1, wherein the at least two first magnetic cylinders and the at least one second magnetic cylinder have a cylinder, triangular prism, rectangular, or polygonal prism shape.

12. The coupled inductor according to claim 1, wherein the top and bottom surfaces of two opposite magnet yokes have a round, triangular, rectangular, or polygonal shape.

13. A power converter comprising:
at least two power bridge arms; and
a coupled inductor comprising:
a magnetic core comprising:
at least two first magnetic cylinders;
at least one second magnetic cylinder; and
two opposite magnet yokes, wherein the at least two first magnetic cylinders and the at least one second magnetic cylinder are disposed between the two opposite magnet yokes; and
at least two windings respectively located on the at least two first magnetic cylinders, wherein the at least two windings are in a one-to-one correspondence with the at least two first magnetic cylinders, and
wherein the at least two windings of the coupled inductor are respectively connected to the at least two power bridge arms.

14. The power converter according to claim 13, wherein a cross section of the at least one second magnetic cylinder is set to enable inductance of leakage inductance that is generated by the coupled inductor when the coupled inductor is connected to a power converter to meet a requirement for inductance, which is needed by the power converter, of a filter inductor.

15. The power converter according to claim 14, wherein magnetic permeability of the at least two first magnetic cylinders is greater than magnetic permeability of the at least one second magnetic cylinder.

16. The power converter according to claim 15, wherein the at least two first magnetic cylinders comprise N first magnetic cylinders, wherein the at least one second magnetic cylinder comprises N−1 second magnetic cylinders, wherein each second magnetic cylinder of the N−1 second magnetic cylinders is disposed between two first magnetic cylinders of the N first magnetic cylinders, and wherein N is an integer greater than or equal to 2.

17. The power converter according to claim 16, wherein the at least two first magnetic cylinders comprise two first magnetic cylinders, and wherein the at least one second magnetic cylinder comprises one second magnetic cylinder.

18. The power converter according to claim 16, wherein the at least two first magnetic cylinders comprise three first magnetic cylinders, and wherein the at least one second magnetic cylinder comprises two second magnetic cylinders.

19. The power converter according to claim 13, wherein the at least two first magnetic cylinders comprise three first magnetic cylinders, wherein the at least one second magnetic cylinder comprises one second magnetic cylinder, wherein the three first magnetic cylinders are arranged in a triangle, and wherein the second magnetic cylinder is disposed in the middle of the triangle.

20. The power converter according to claim 1, wherein the at least two first magnetic cylinders comprise two first magnetic cylinders, wherein the at least one second magnetic cylinder comprises one second magnetic cylinder, and wherein the two first magnetic cylinders and the second magnetic cylinder are arranged in a triangle.
